(19) United States
(12) Patent Application Publication
(10) Pub. No.: US 2005/0082702 A1
(43) Pub. Date: Apr. 21, 2005

(54) Method for producing dentures or an artificial tooth

(76) Inventor: Ulrich Wennemann, Umkirch (DE)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/501,593

(22) PCT Filed: Jan. 17, 2003
(86) PCT No.: PCT/EP03/00440

(30) Foreign Application Priority Data
Feb. 12, 2002 (DE) 102 05 739.7

(51) Int. Cl. A61C 13/00

(52) U.S. Cl. 264/16

(57) ABSTRACT

A method of producing a ceramic part by injecting in a powder injection molding process a ceramic molding material composed of at least one ceramic powder and one binder into the inner cavity of a molding tool under the effect of heat and/or pressure. The molding material solidifies in the inner cavity to form a green body perform. After injection of the molded perform, at least one further ceramic molding material is injected onto the previously produced green body perform under the effect of heat and/or pressure in at least one further powder injection molding process. The molding materials of at least two of the injection molding processes are different from each other. The multi-component molded perform obtained by the powder injection molding process has the binder stripped and is then sintered to produce the finished ceramic part.

### BACKGROUND

The invention relates to a method for producing a ceramic part formed as dentures or an artificial tooth, especially as a bridge. In a powder injection molding process, a ceramic molding material, which contains at least one ceramic powder and one binder as components, is injected into the inner cavity of a molding tool under the effect of heat and/or pressure and solidifies into a green body preform.

For a method known from DE 42 10 781 C2 for producing artificial teeth, initially a ceramic core, which has the color of dentin, is fired. Here, the size of the core is small relative to the size of the finished artificial tooth. Then, both the dentin material and also a melt layer composed of dental-ceramic materials are deposited on the core by the dental technician. Then the artificial tooth prepared in this way is fired at temperatures of 900-960° C. Firing leads to a fixed and permanent connection of the various ceramic materials. Thus, because the size of the core is small relative to the size of the corresponding artificial tooth, the dental technician can deposit both the opaque dentin material and also transparent melt layers composed of dental-ceramic materials on the core. The resulting artificial teeth correspond relatively well to natural teeth in terms of color and visual properties. However, the production of these artificial teeth is still comparatively complicated and expensive.

### SUMMARY

Therefore, there is the objective of creating a method of the type mentioned in the introduction, which enables an economical series production of dentures or artificial teeth, especially bridges.

To meet this objective, after injection of the green body preform, at least one further powder injection molding process is used to inject at least one other ceramic molding material under the effect of heat and/or pressure onto the previously produced green body preform. Here, the molding materials of at least two of the powder injection molding processes differ from each other, and the multi-component green body preform obtained by the powder injection molding process is subjected to stripping of the binder and sintering to form the final ceramic part.

Thus, in an advantageous way, this method results in a ceramic part, which is formed of several ceramic components connected to each other tightly and permanently and which can be manufactured economically using powder injection molding technology. Thus, complicated manual processing of the ceramic part can be spared. For the individual powder injection molding processes, advantageously form materials with similar or identical properties are used, which are adapted to each other such that during the binder stripping process, the binder is almost completely removed or is completely removed from the green body preform.

For an especially advantageous embodiment of the invention, the multi-component green body preform is exposed to a low pressure during the sintering process and the low pressure or the low-pressure profile is adapted to the temperature or the temperature profile of the sintering process, such that at least one outer ceramic component produced by powder injection molding, and preferably all of the powder-injected ceramic components of the ceramic part, is (are) for the most part or are completely pore-free after completion of the sintering process. This enables, on one hand, a high strength of the ceramic part and, on the other hand, the production of a ceramic part with one or more optically transparent, powder-injected ceramic components.

For an advantageous embodiment of the invention, the melting temperatures of the ceramic powders used for powder injection molding of two directly adjacent ceramic components of the multi-component green body preform differ by less than 150° C., especially by less than 100° C., and preferably by less than 50° C. These measures allow a simple and nearly or completely residue-free removal of the binder from the green body preform with known binder stripping processes, e.g., catalytic stripping. The subsequent sintering process produces a fixed and permanent connection of the individual ceramic components of the ceramic part.

Advantageously, the coefficient of thermal expansion of the powders used for powder injection molding of two directly adjacent ceramic components of the multi-component green body preform differ by less than 15%, especially by less than 10%, and preferably by less than 5%. Also, these measures produce a macroscopic or microscopic defect-free connection of the individual ceramic components of the ceramic part.

A fixed and permanent connection of the individual ceramic components of the ceramic part can also be achieved, such that the grain size of the ceramic powders is less than 50 μm, especially less than 30 μm, and preferably less than 10 μm.

For an advantageous carrying out of the method, the green body preform produced in the first powder injection molding process is at least partially coated and if necessary completely coated with a ceramic molding material in at least one other powder injection molding process. These measures produce a ceramic part, which has a layer arrangement with two or more ceramic layers. In this way, it is even possible that at least one layer forms a ring-shaped border for at least one other layer.

For one advantageous embodiment of the invention, the ceramic powder of at least one powder injection molding process is electrically conductive and the ceramic powder of at least one other powder injection molding process is electrically insulating. The electrically conductive powder can be used to produce, e.g., a ceramic component of the ceramic part formed as an electrical conductor, especially as a conductive guide. The electrically insulating powder can be used to produce an insulating ceramic component of the ceramic part bounding or covering the conductor or the conductive guide. Thus, the method can also find advantageous use in electrical and/or in the electronics industry.

For a preferred embodiment of the invention, the ceramic powder of at least one powder injection molding process is formed such that the ceramic component of the final ceramic part produced from this powder is transparent or translucent, while the ceramic powder of at least one other powder injection molding process is formed such that the ceramic component of the final ceramic part produced from this powder is less transparent than the other ceramic component. The method according to the invention is especially suited for producing artificial teeth, bridges, or similar dentures. In this way, the transparent or translucent ceramic component of the ceramic part is arranged at the outer wall of the bridge or the dentures, so that the opaque ceramic component located behind the transparent component shines through the transparent or translucent ceramic component. These measures produce a natural coloring effect and transparency of the ceramic tooth substance. The method according to the invention can produce different tooth types, shapes, and sizes.

In one advantageous embodiment of the invention, a carrier part is inserted in the inner cavity of the molding tool in positive-fit connection and at least one ceramic molding material is injected onto this carrier part in at least one powder injection molding process. In this way, it is even possible that the carrier part is coated with the molding material or the molding materials are molded in a ring-shape thereon. The carrier part provides a high flexural, fracture, and/or tensile strength to the ceramic part. The carrier part can have at least one anchoring projection, which is used for fastening the ceramic part.

The carrier part can be formed of a metallic material. The carrier part is then produced with known methods, e.g., through casting.

For a preferred embodiment, the carrier part is formed of a ceramic material, preferably zirconium oxide, aluminum oxide, silicon nitride, and/or silicon carbide. The carrier part then has a comparatively large mechanical load capacity. In a method for producing bridges or dentures, the ceramic material of the carrier part also has the advantage of good biological compatibility.

For one advantageous configuration of the invention, the carrier part has at least one anchoring projection, which has side walls extending perpendicular to each other, such that for at least one powder injection molding process a ceramic molding material can be injected onto at least one of the side walls, such that it projects laterally over the edge of this side wall or the straight extension of at least one side wall adjacent to this side wall by a degree of overhang and such that the degree of overhang is selected with consideration for shrinkage occurring during stripping of the binder and/or sintering of the green body preform, such that the injected molding material after the sintering ends flush with the edge of the side wall with the molding material or the straight extension of the one or more side walls adjacent to this side wall. The method then enables in a simple way the production of bridges with greater flexural, fracture, and/or tensile strength, wherein the regions of the bridges that are visible in the position of use correspond approximately to the coloring and transparency of a natural tooth. Because the molding material injected onto the anchoring projection for the final bridge ends flush with the edge of the side wall with the molding material or the straight extension of the one or more side walls adjacent to this side wall, the bridge enables a simple preparation of the neighboring teeth provided for anchoring the bridge with the device known from DE 199 48 393 C1.

It should also be mentioned that several ceramic powder injection molding layers can also be applied using the method according to the invention.

### BRIEF DESCRIPTION OF THE DRAWINGS

In the following, an embodiment of the invention is explained in more detail with reference to the drawing. In the drawings:

FIG. 1 is a longitudinal side view of a carrier part,

FIG. 2 is a side view of a green body preform produced by molding on of a ceramic molding material on the carrier part, wherein hidden edges of the carrier part are shown by dashed lines,

FIG. 3 is a longitudinal side view of a multi-component green body preform produced by molding of another ceramic component on the green body preform shown in FIG. 2, wherein hidden edges are shown by dashed lines,

FIG. 4 is a longitudinal side view of a ceramic part produced by stripping the binder and sintering the green body preform shown in FIG. 3,

FIG. 5 is a narrow-side view of the ceramic part shown in FIG. 3,

FIG. 6 is a narrow-side view of the ceramic part shown in FIG. 4,

FIG. 7 is a top view of a first molding tool part of an injection molding machine, which is clamped on a first molding plate of a closing device,

FIG. 8 is a top view of a second molding tool part of an injection molding machine, which is clamped on the second molding plate of the closing device, and

FIG. 9 is an enlarged partial top view of the second molding tool part, with a carrier part inserted in the inner cavity of this molding tool part.

### DETAILED DESCRIPTION OF THE PREFERRED EMBODIMENTS

A powder injection molding machine for producing a ceramic part 1 formed as a bridge for replacing at least one missing tooth has an injection device not shown in more detail in the drawing for injecting a ceramic molding material into the inner cavity of a tempered molding tool and a mold closing device for opening and closing the molding tool. The injection device has a filling opening, into. which granular material is filled, which contains as components at least one ceramic powder and one thermoplastic binder. The filling opening is connected to an injection nozzle via a known extruder barrel. In the extruder barrel, a conveyor worm is arranged, in which the granulate is melted under the effect of pressure and heat into a meltable molding material and conveyed to the injection nozzle. For injecting the ceramic molding material into the inner cavity of the molding tool, the injection nozzle can be positioned at an inlet opening of a supply channel provided in the molding tool for the molding material.

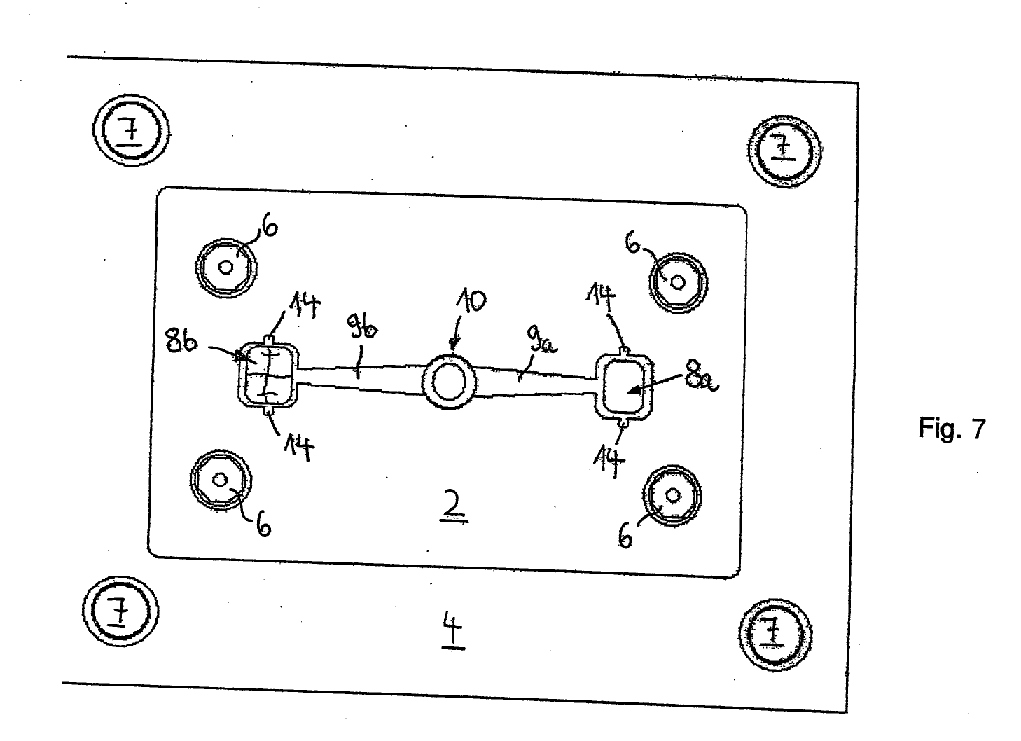

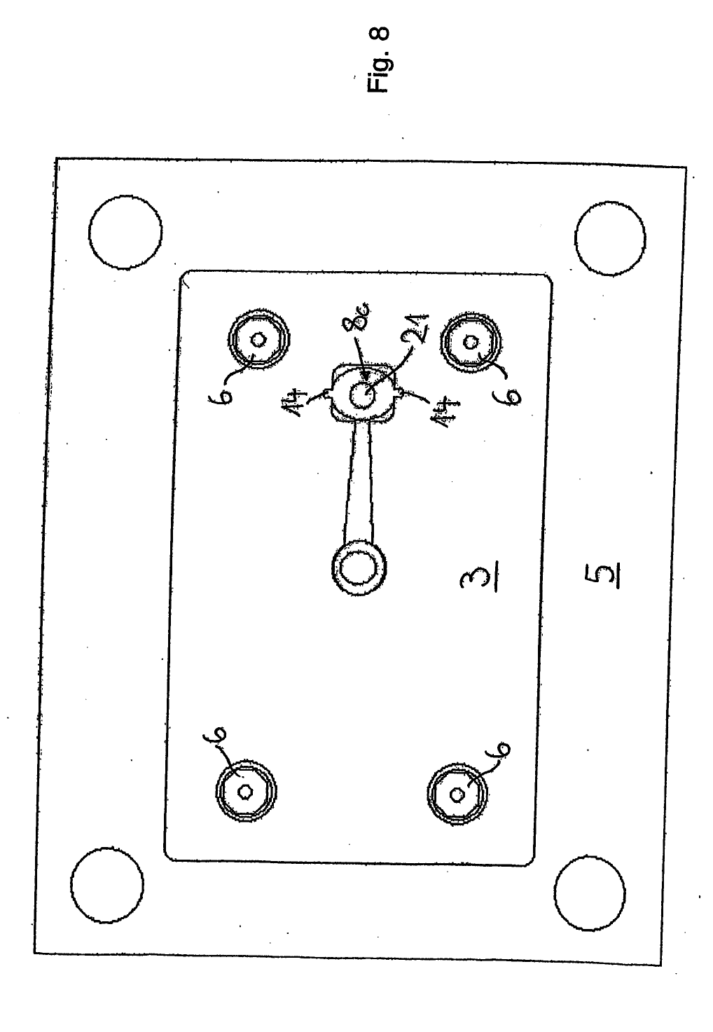

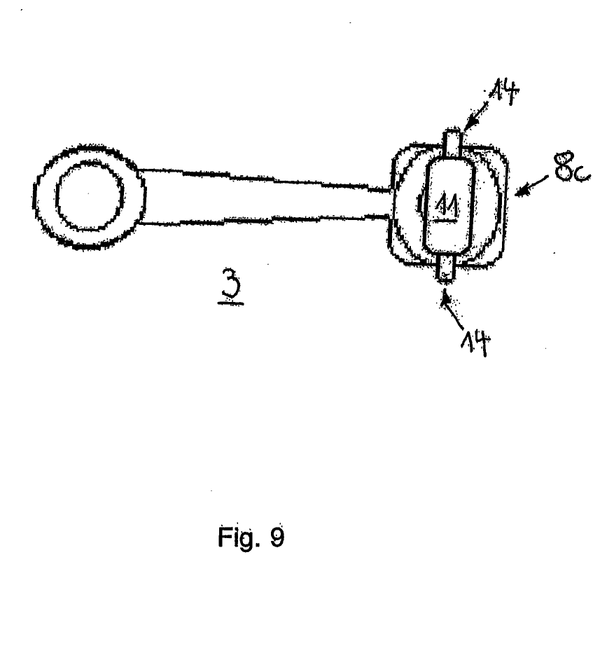

In FIGS. 7 and 8 it can be seen that the molding tool has a first molding tool part 2 and a second molding tool part 3, which can be adjusted between an open position and a closed position relative to each other. The first molding tool part 2 is mounted on the first molding plate 4 and the second molding tool part 3 is mounted on a second molding plate 5 with clamping elements 6 in a predetermined position. Guide columns 7 are arranged on the first molding plate 4, in a known manner, and extend perpendicular to the extension planes of the molding tool parts 2, 3. The second molding plate 5 for opening and closing the molding tool is supported on the guide columns 7 so that it can be moved towards and away from the first molding plate.

In FIGS. 7 and 8 it can be further seen that the inner area of the molding tool has cavities, which are provided on both sides of the separating plane of the molding tool in the walls of the molding tool parts 2, 3 that face each other in the position of use. The molding tool is formed as a turning tool, whose molding tool parts 2, 3 can be brought into turning positions arranged offset from each by 180° relative to a turning axis in the closed position.

In FIG. 7 it can be seen that the first molding tool part 2 on the injection nozzle side has a first cavity 8a and a second cavity 8b, which are arranged offset from each other by 180° relative to the turning axis. A third cavity 8c is provided in the second molding tool part 3. In a first turning position, the third cavity 8c lies opposite the first cavity 8a for a molding tool located in the closed position and forms with this a first inner cavity. In a second turning position, the third cavity 8c lies opposite the second cavity 8b for a molding tool located in the closed position and forms with this a second inner cavity, whose dimensions are greater than those of the first inner cavity.

The cavities 8a, 8b are each connected via a branch 9a, 9b of the supply channel to a branching position 10, which is attached to the injection nozzle via a common supply channel section. For selective connection of the supply channel branches 9a, 9b to the injection nozzle, a locking element not shown in more detail in the drawing is arranged at the branching position.

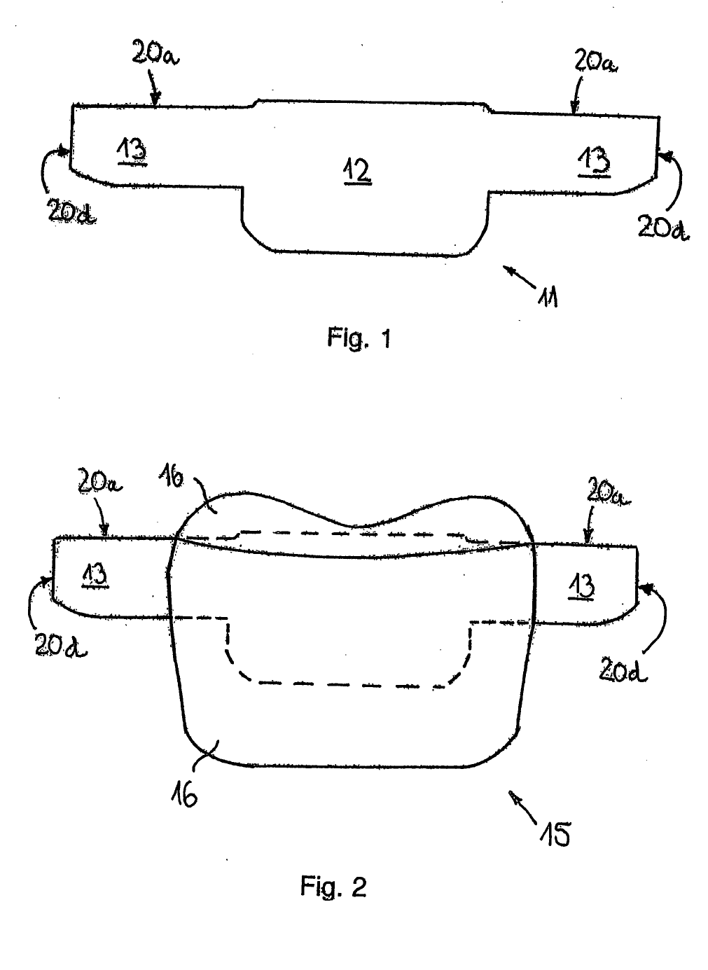

For the production of bridges, initially a bridge-like carrier part 11 is manufactured. As can be seen in FIG. 1, the carrier part 11 has a central region 12 with anchoring projections 13 that extend to both sides and that are formed by the free ends of the carrier part 11. As material for the production of the carrier part 11, a bio-compatible ceramic is used, especially a zirconium oxide ceramic, which is preferred due to its high hardness value. However, it is also possible to produce the carrier part 11 from an alloyed or non-alloyed metallic material, e.g., from gold or titanium.

For the molding tool located in the open position, the carrier part 11 with the anchoring projections 13 is inserted into matching receptacles 14 of the cavity 8a or 8c. Then the molding tool located in the first turning position is closed. The dimensions of the inner cavity formed by the cavities 8a, 8c, especially the open width between the receptacles 14, are adapted to the dimensions of the carrier part 11, such that this is held in the closed position of the molding material in a positive-fit connection in the inner cavity.

Thus, the carrier part 11 is positioned exactly in the inner cavity in a predetermined position.

In a first powder injection molding process, a first ceramic molding material is injected into the first inner cavity of a molding tool under the effect of heat and pressure for forming a first green body preform 15. The first ceramic molding material can be known dental ceramic, which contains a dentin powder and a thermoplastic binder. The ceramic powder is formed such that the ceramic components of the ceramic part 1 produced from this powder is opaque or less transparent.

As the binder, a commercially available binder for ceramic injection molding can be used, e.g., a binder that can be subjected to water debinding, solvent debinding, catalytic debinding, and/or thermal debinding.

In FIG. 2 it can be seen that for the first powder injection molding process, a first ceramic component 16 is injected onto the carrier part 11, which borders the central region 12 of the carrier part 11 and the sections of the anchoring projections 13 adjacent to the central region 12 in a ring-shape. The free ends of the anchoring projections 13 contact tightly to the adjacent wall of the receptacles 14 during the powder injection molding process, so that they do not come into contact with the ceramic molding material.

After the ceramic molding material solidifies, the molding tool is opened. The cavities 8a and 8c are formed such that the second molding tool part 3 detaches during opening of the molding tool from the green body preform 15, while this remains in the cavity 8a of the first molding tool part 3. The molding tool located in the open position is then brought into the second turning position and closed again for performance of a second powder injection molding process. In the closed position of the molded tool, the cavities 8b and 8c form a second inner cavity, which holds the green body preform 15.

In the second powder injection molding process, for forming the multi-component second green body preform 17, a second ceramic molding material is injected into the second inner cavity under the effect of heat and/or pressure. This molding material can be a known dental ceramic, which contains a melting ceramic powder and a thermoplastic binder. The composition of the ceramic powder differs from that of the ceramic powder used for the first powder injection molding process in so far as the ceramic component produced in the second powder injection molding process is more transparent than the ceramic component produced in the first powder injection molding process. Additionally, the composition of the first ceramic powder used for the second powder injection molding process is essentially similar to the composition of the first ceramic powder used for the first powder injection molding process.

A commercially available binder for ceramic injection molding can be used as the binder for the second powder injection molding process, which preferably agrees with the binder used for the first powder injection molding process.

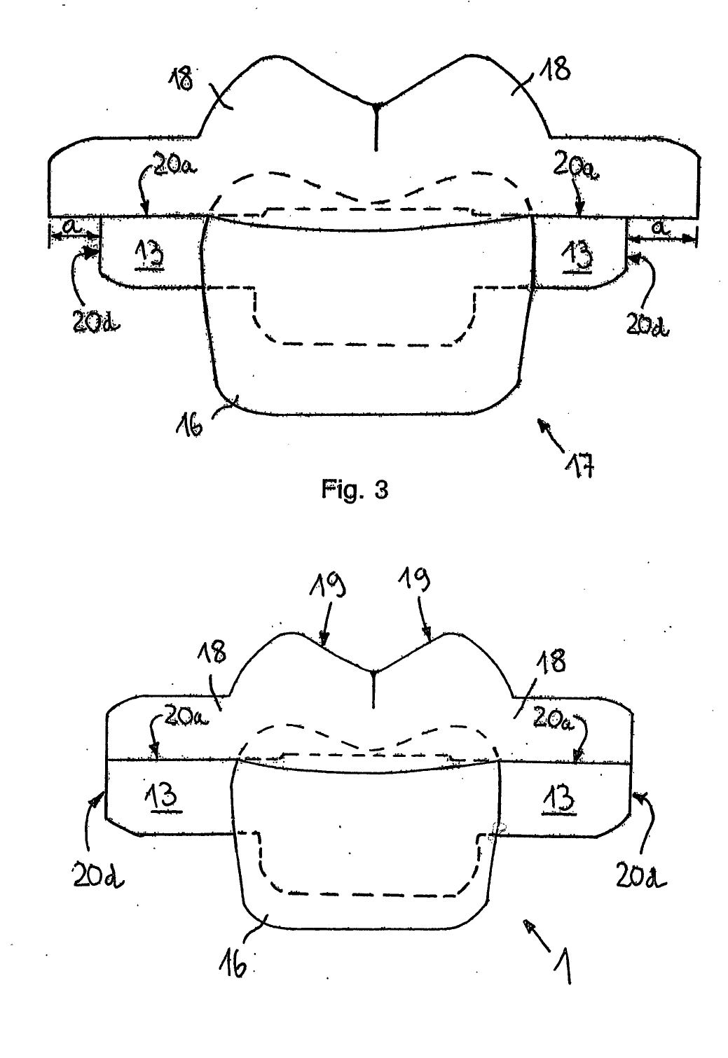

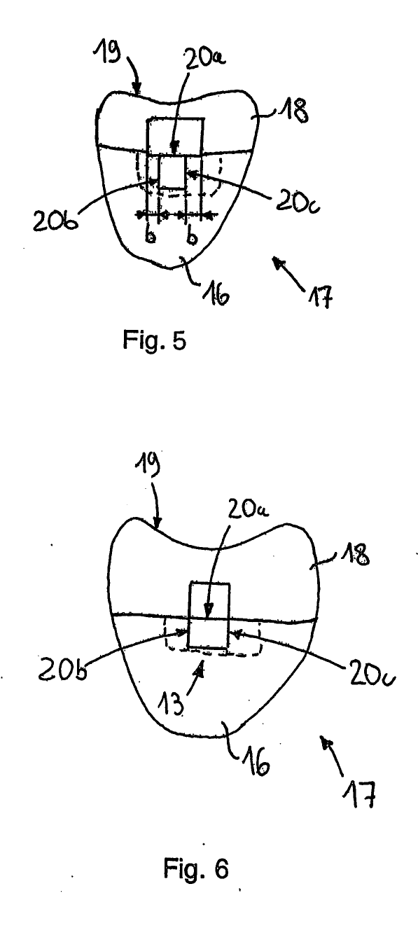

In FIG. 3, it can be seen that for the second powder injection molding process, a second ceramic component 18 is injection molded onto the first green body preform, which forms the chewing surface 19 for the final bridge. In FIGS. 3 and 5, it can be seen that the anchoring projections 13 of the carrier part 11 each have side walls 20a, 20b, 20c, 20d extending perpendicular to each other and that the second ceramic component 18 for the second powder injection molding process is molded on the side wall 20a of the corresponding anchoring projection facing the chewing surface 19 for the second powder injection molding process, such that it completely covers the side wall 20a and projects with a peripheral edge region laterally over the edge of the side wall 20a.

After the green body preform 17 solidifies, the molding tool is opened and the green body preform 17 is ejected or removed from the second molding tool part 3 with the help of an ejection pin 21. Then, the green body preform 17 is subjected to a binder stripping process, wherein at least the binder contained in the outer layer of the ceramic material is removed from this preform.

Then the green body preform 17 is sintered under the effect of heat and low pressure. The low pressure or the low-pressure profile is adapted to the temperature or the temperature profile of the sintering process, such that at least the outer ceramic component 18 produced by the powder injection molding, and preferably all of the powder-injected ceramic components 16, 18 of the ceramic part 1 is (are) for the most part or completely pore-free after completion of the sintering process. The outer ceramic component 18 then corresponds in terms of transparency and coloring to that of a natural tooth enamel or is at least similar in terms of transparency and coloring to that of natural tooth enamel.

The molding materials used for adjacent ceramic components 16, 18 of the ceramic part 1 in the individual powder injection molding processes are adapted to each other in terms of their melting points and their coefficients of thermal expansion such that during sintering a fixed and essentially crack-free connection between the ceramic components 16, 18 is produced.

The temperature of the sintering process is selected to be less than the melting temperature of the material of the carrier part 11, so that the strength of the carrier part 11 is not affected or only insignificantly reduced by the sintering process. Then, for the sintering process, a fixed mechanical connection is also achieved between the carrier part 11 and the adjacent ceramic components 16, 18.

During the binder stripping and/or sintering, the ceramic components 17, 19 are compressed, wherein the green body preform 17 shrinks to the dimensions desired for the final ceramic part.

The degree of overhang a, b, by which the ceramic component 18 of the green body preform 17 projects laterally over the edge of the side wall 20a, is selected under consideration of the shrinkage occurring during the binder stripping and/or sintering, such that the second ceramic component 18 ends flush with the edge of the side wall 20a after sintering (FIGS. 4 and 6).

The bridge part can be anchored in a simple way on the teeth of a patient with the help of a device known from DE 199 48 393 C1. Here, receptacles that match exactly to the anchoring projections 13 of the bridge part are formed in the teeth adjacent to the gap to be filled by the tooth bridge. Then the bridge part with the anchoring projections 13 is inserted into these receptacles. A possibly remaining gap between the anchoring projections 13 and the receptacles of the adjacent teeth is bridged with adhesive, cement, or a similar sealing means.

1. Method for producing a ceramic part (1) formed as a denture, an artificial tooth or a bridge, comprising in a powder injection molding process, injection molding a ceramic molding material, which contains as components at least one ceramic powder and one binder, into an inner cavity of a molding tool under the effect of heat and/or pressure and solidifing this into a green body preform (15), and after injecting the green body preform (15), injection molding at least one other ceramic molding material on the previously produced green body preform (15) under the effect of heat and/or pressure in at least one other powder injection molding process, the molding materials of at least two of the powder injection molding processes differ from each other, and subjecting the multi-component green body preform (17) obtained by the powder injection molding process to binder stripping and sintering to form the final ceramic part (1).

2. Method according to claim 1, further comprising exposing the multi-component green body preform (17) to a low pressure during the sintering process and the low pressure or the low-pressure profile is adapted to a temperature or a temperature profile of the sintering process, so that at least one outer ceramic component (18) produced by the powder injection molding, or all of the powder-injected ceramic components (16, 18) of the ceramic part (1), is/are nearly completely or completely pore-free after completion of the sintering process.

3. Method according to claim 1, wherein melting temperatures of the ceramic powder used for the powder injection molding of two directly adjacent ceramic components (16, 18) of the multi-component green body preform (17) differ by less than 150° C.

4. Method according to claim 1, wherein coefficients of thermal expansion of the ceramic powder used for powder injection molding of two directly adjacent ceramic components (16, 18) of the multi-component green body preform (17) differ by less than 15%.

5. Method according to claim 1, wherein a grain size of the ceramic powder is less than 50 μm.

6. Method according to claim 1, wherein the green body preform (15) produced in the first powder injection molding process is at least partially coated or completely coated with a ceramic molding material in the at least one other powder injection molding process.

7. Method according to claim 1, wherein the ceramic powder of at least one powder injection molding process is electrically conductive and the ceramic powder of at least one other powder injection molding process is electrically insulating.

8. Method according to claim 1, wherein the ceramic powder of the at least one powder injection molding process is formed, such that the ceramic components (16, 18) of the final ceramic part (1) formed from the ceramic powder is transparent or translucent, and the ceramic powder of at least one other powder injection molding process is formed such that the ceramic component (16, 18) of the final ceramic part produced from this powder is less transparent than the other ceramic component (18, 16).

9. Method according to claim 1, wherein a carrier part (11) is inserted in an inner cavity of the molding tool in a positive-fit connection, and for the at least one powder injection molding process, at least one ceramic molding material is injection molded onto this carrier part (11) and if necessary, the carrier part (11) is injection molded with the molding material or the molding materials in the shape of a ring.

10. Method according to claim 1, wherein the carrier part (11) is formed of a metallic material.

11. Method according to claim 1, wherein the carrier part (11) is formed of a ceramic material.

12. Method according to claim 1, wherein the carrier part (11) has at least one anchoring projection (13), which has side walls (20a, 20b, 20c) extending perpendicular to each other, in at least one of the powder injection molding processes a ceramic molding material is coated on at least one of the side walls (20a, 20b, 20c), such that it projects laterally over the edge of this side wall (20a, 20b, 20c) or the straight extension of at least one side wall (20a, 20b, 20c) adjacent to this side wall (20a, 20b, 20c) by a degree of overhang, and the degree of overhang is selected under consideration of shrinkage occurring during binder stripping and/or sintering of the green body preform, such that the injected on molding material ends flush with an edge of the side wall (20a, 20b, 20c) with the molding material or the straight extension of the one or more side walls (20a, 20b, 20c) adjacent to this side wall (20a, 20b, 20c) after sintering.
